(19) United States
(12) Patent Application Publication
(10) Pub. No.: US 2010/0122988 A1
(43) Pub. Date: May 20, 2010

(54) Tank liquid level gauge system

(76) Inventor: Shane H. Clanton, Horseshoe Bay, TX (US)

Correspondence Address: Christopher J. Whewell;Western Patent Group, 6020 Tonkowa Trail, Georgetown, TX, 78628, US

(21) Appl. No.: 12/313,390

(22) Filed: Nov. 20, 2008

(51) Int. Cl. G01F 23/58; B65D 90/48; B65D 88/02

(52) U.S. Cl. 220/565; 73/321

(57) ABSTRACT

A fouling-resistant arrangement useful for guiding lengths of cables having functional devices including a float, counterweight, and indicator bob attached at their ends, collectively useful in indicating the liquid level of a storage tank to which a system as herein provided is attached, to a passer-by upon casual glance.

### TECHNICAL FIELD

This invention relates generally to tanks in which liquid substances are stored. More particularly, it relates to gauges and apparati capable of being affixed to an external surface of a storage tank, for indicating the level of a liquid substance disposed within the tank.

### BACKGROUND OF THE INVENTION

Storage tanks in which liquids are to be held until the time of their use or consumption have been in use since the earliest of times. Typically, liquids including water, solvents, hydrocarbons, and oils are commonly contained in liquid storage tanks.

It is generally desirable for a person whose activities concern use of a liquid contained within a storage tank to have a method or means by which the amount of liquid within the tank can be known. One example of a helpful means in this regard is the fuel tank gauge on modern motorized vehicles, such as automobiles and trucks. Another example includes tank farms at petrochemical refineries which often have electronic level-sensing means operatively connected to a microprocessor which may be accessed by an operator.

In other instances, tanks are used to store water for human or agricultural use. In such instances it is sometimes desired to use a mechanical gauging means, which is readily visible by a person passing by such a tank upon casual glance. However, mechanical gauges are susceptible to freezing rain, which can foul their mechanism and result in erroneous readings. An additional difficulty is that insects and small birds sometimes find enclosures associated with mechanical gauging means to be a convenient location to build their nests, which frequently foul operation of such gauges.

### SUMMARY OF THE INVENTION

Apparatus useful for indicating the level of a liquid disposed in a liquid storage vessel. An apparatus according to this disclosure comprises a frame portion having a wall and a lower flange. The lower flange includes a plurality of holes disposed through it. There is a first pair of pulleys affixed to the frame and a second pair of pulleys affixed to the frame. There is a first length of cable having a first end and a second end. The first length of cable is in contact with each pulley of the first pair of pulleys, and passes through the lower flange at two different locations. There is a second length of cable having a first end and a second end. The second length of cable is in contact with each pulley of the second pair of pulleys, and passes through the lower flange at two different locations. A float is attached to the first end of the first cable, an indicator bob is attached to the first end of the second cable, and a counterweight is attached to the second end of the first length of cable and to the second end of the second length of cable.

### BRIEF DESCRIPTION OF THE DRAWINGS

Embodiments of invention may take physical form in certain parts and arrangement of parts, the preferred embodiment of which will be described in detail and illustrated in the accompanying drawings which form a part hereof, and wherein:

FIG. 1 shows a perspective view of a main frame portion of an assembly according to an embodiment of the present invention;

FIG. 2 shows a frontal view of a main frame portion of an assembly in accordance with an embodiment of the present invention;

FIG. 3 shows a side perspective view of a main frame portion of an assembly in accordance with an embodiment of the present invention;

FIGS. 4, 5, and 6 show side, perspective and end views of a pulley assembly according to the prior art that is useful in an embodiment of the present invention;

FIG. 7 shows a perspective view of a main frame portion of an assembly according to an embodiment of the present invention, including useful hardware;

FIG. 8 shows a perspective view of a main frame portion of an assembly according to an embodiment of the present invention, including useful hardware and other elements useful in an embodiment of the present invention;

FIG. 9 shows a front perspective view of a cover for a main frame portion of an assembly according to an embodiment of the present invention;

FIG. 10 shows a front view of a cover for a main frame portion of an assembly according to an embodiment of the present invention;

FIG. 11 shows a rear perspective view of a cover for a main frame portion of an assembly according to an embodiment of the present invention;

FIG. 12 shows an exploded view of various components of an assembly provided in accordance with one embodiment of the invention;

FIG. 13 shows a perspective view of the components shown in FIG. 14, partially assembled; and

FIG. 14 shows a schematic cross-section of a tank equipped with a tank liquid level gauge system as provided according to one embodiment of the invention.

### DESCRIPTION OF THE PREFERRED EMBODIMENT

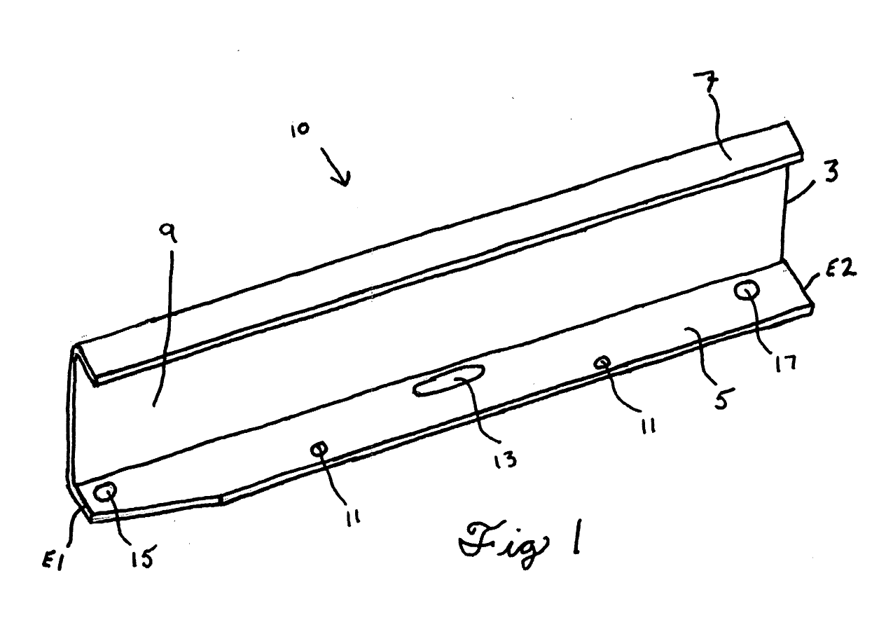

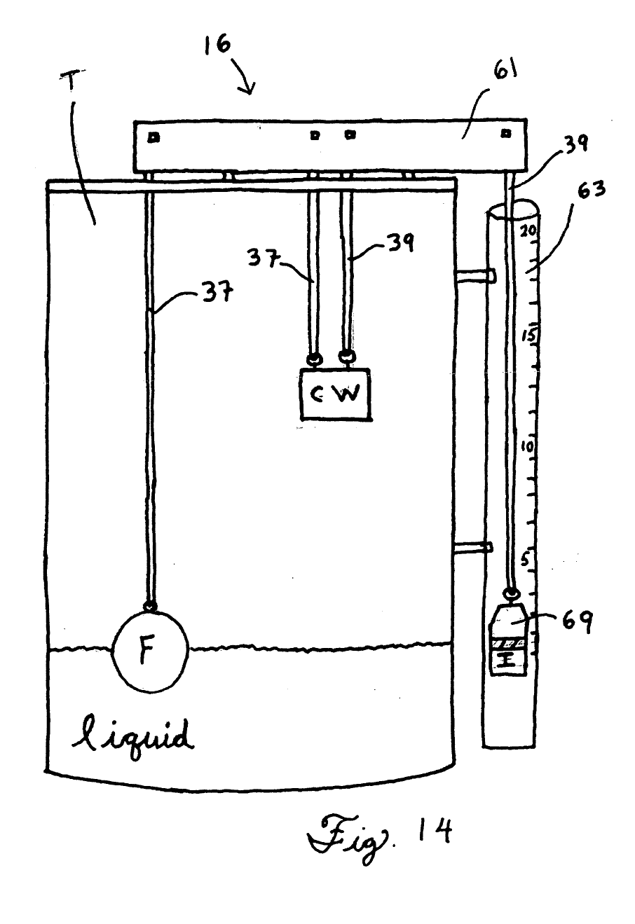

Referring to the drawings, presented as being illustrative of the invention only and not being delimitive of same, FIG. 1 provides a perspective view of a main frame 10 of a gauge control assembly 16 (FIG. 14) according to an embodiment of the present invention. In this embodiment, the main frame 10 includes a wall 3 having an interior surface 9. There is an upper flange 7 disposed along the upper edge of the wall 3, and a lower flange 5 disposed along the lower edge of the wall 3. The lower flange 5 includes mounting holes 11 disposed through its surface, to enable conventional fasteners including screws, rivets, and bolts to pass through, for affixing the main frame 10 to a selected surface, which includes the top of a tank in which a liquid substance is contained. In this embodiment there is further provided a provision for enabling a cable to pass, which provision comprises slot 13 disposed through the surface of the lower flange 5. In this embodiment there are also holes 15, 17 disposed through the surface of the lower flange 5, which holes enable passage of a cable therethrough, as will be described. In some embodiments, the hole 15 is disposed closer to end E1 of frame 10 than hole 17 is disposed with respect to end E2 of frame 10. In one non-limiting embodiment, the distance from the center of hole 15 from end E1 is about equal to the diameter of hole 15 and the distance from the center of hole 17 from end E2 is about three times the diameter of hole 17. The tapered portion of the lower flange 5 near end E1 is provided for identifying which end of a combination according to the disclosure from which indicator bob 69 (described later) hangs, in some embodiments. In some embodiments, when installed on a tank, it is desirable that the end of the frame having this tapered lower flange portion be level with, or lower than the non-tapered end, when this optional taper is selected to be present.

In one embodiment, the main frame 10 is fabricated from a single piece of material stock. In other embodiments, the main frame may comprise separate pieces, such as a separate wall 3, upper flange 7, and lower flange 5, which are attached to one another to provide the construct shown in FIGS. 1, 2, 3, by conventional fastening that may include rivets, screws, nuts and bolts and welding. When the main frame 10 is selected to be fabricated from a single piece of material stock, sheet metal may be selected as the material of construction. Sheet metal includes without limitation sheet steel, galvanized and non-galvanized, and also all grades of stainless steels. In one embodiment, the main frame 10 is fabricated from sheet stock stainless steel, by bending, drilling and cutting. In other embodiments, the main frame 10 and at least one other component of an assembly as herein described, is comprised of a polymeric material, including materials selected from the group consisting of: thermoplastic resins and thermoset resins, and made by an injection molding process. In one embodiment polypropylene is selected as a thermoplastic resin.

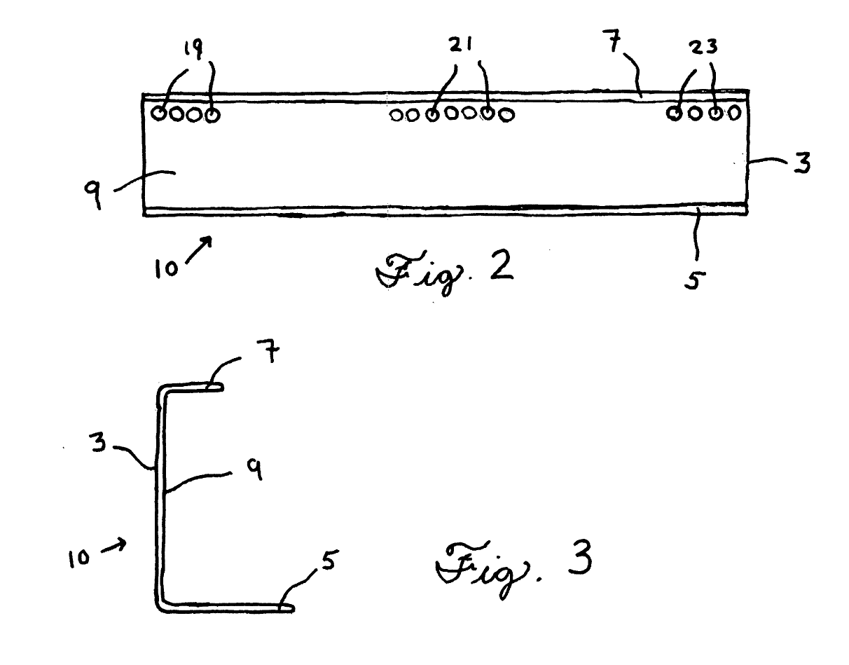

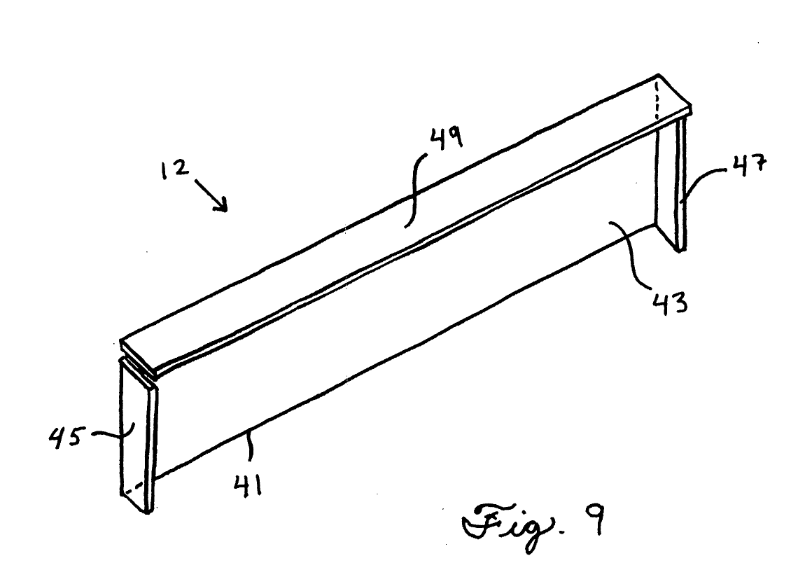

In FIG. 2 is shown a frontal view of a main frame 10 of an assembly in accordance with one embodiment of the present invention. In FIG. 2 are shown the respective locations of the wall 3, lower flange 5, and upper flange 7. Also shown in relation to one embodiment, are disposed at the top of the wall 3 a first plurality of holes 19, a second plurality of holes 21, and third plurality of holes 23. The holes in these pluralities of holes extend through the wall 3 and are useful for providing a location through which mounting hardware may be disposed, such as a pulley support 35 as later described in reference to FIGS. 7, 8, 12, 13. The first, second, and third plurality of holes may each independently comprise any number of holes between about two and about seven, including two and seven, and when provided, such pluralities permit adjustment of the location of a pulley support 35 with respect to the length dimension of the main frame 10. Such provision enables accommodation of the use of pulley assemblies 14 (FIG. 5) of various diameters, as may be selected or desired. It also enables adjustment of the location of the pulleys to accommodate tank roofs of various pitches. In an alternate embodiment, any one of the first plurality of holes 19, second plurality of holes 21, and third plurality of holes 23 comprise a single hole. In another alternate embodiment, any two of the first plurality of holes 19, second plurality of holes 21, and third plurality of holes 23 comprise a single hole. In another alternate embodiment, all three of the first plurality of holes 19, second plurality of holes 21, and third plurality of holes 23 each comprise a single hole.

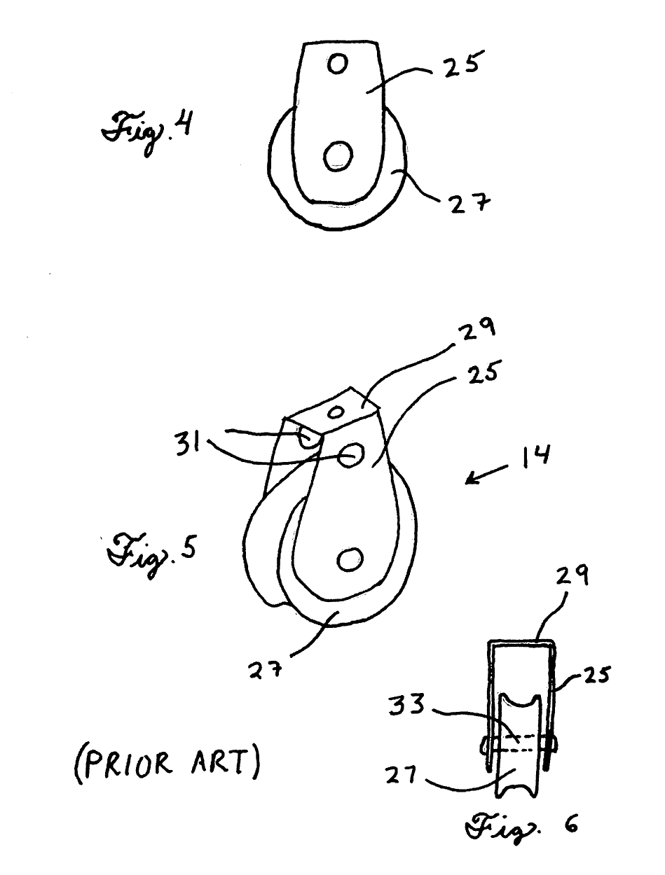

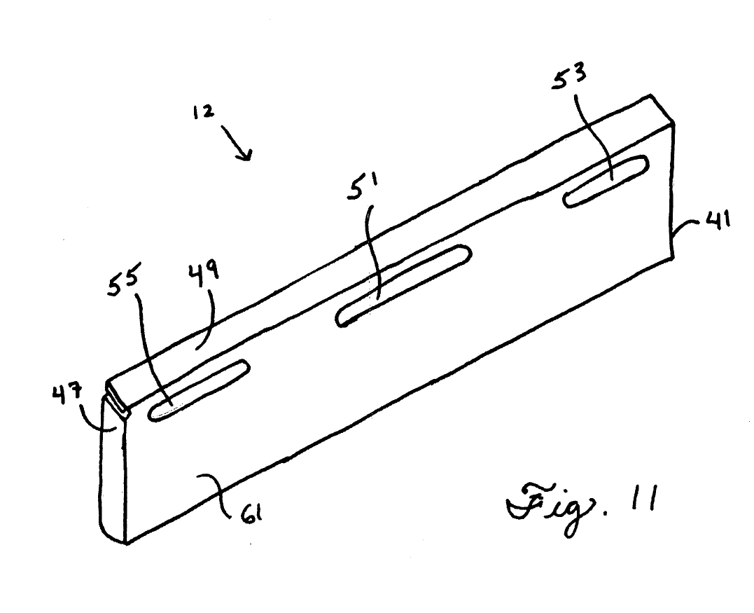

In FIG. 3 is shown a left side perspective view of a main frame 10 of an assembly in accordance with an embodiment of the present invention, showing the respective locations of the wall 3, lower flange 5, upper flange 7 and interior surface 9. In this embodiment, the distal end of the lower flange 5 is farther away in distance from the wall 3 than is the distal end of the upper flange 7. This greater extension of the lower flange 5 with respect to the wall in this embodiment advantageously enables a cover 12 (FIGS. 9, 10, 11) to be affixed to the main frame 10 as later described while providing for accessibility to the mounting holes 11 on the lower flange 5. However, in other embodiments the lower flange 5 extends to substantially same extent that does the upper flange 7, away from the wall 3.

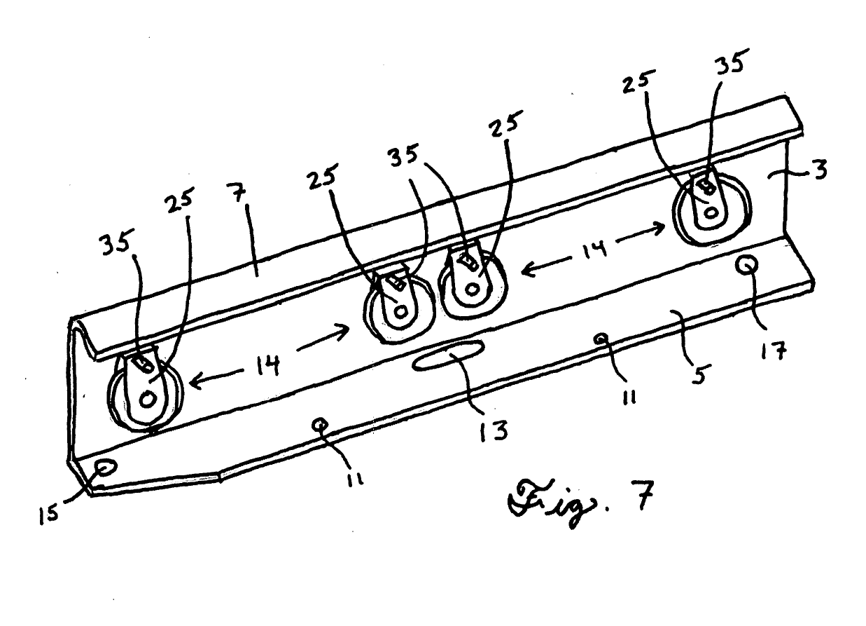

In FIG. 4 is shown a side view of a pulley assembly according to the prior art that is useful in an embodiment of the present invention. In this FIG. 4 are shown the respective locations of the pulley frame 25 and the pulley 27 mounted therein.

In FIG. 5 is shown a perspective view of a pulley assembly according to the prior art that is useful in an embodiment of the present invention. In this FIG. 5 are shown the respective locations of the pulley frame 25 and the pulley 27 mounted therein. The pulley frame 25 has a top of frame 29, and the frame 25 is further provided with holes 31 disposed through its surface which provide the pulley assembly 14 to be mounted as herein described.

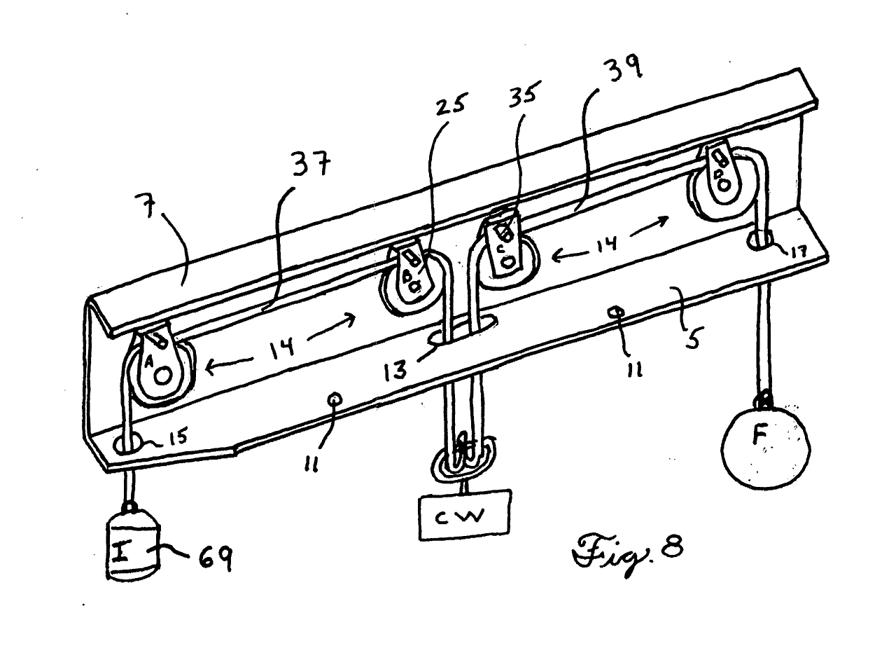

In FIG. 6 is shown an end view of a pulley assembly according to the prior art that is useful in an embodiment of the present invention. The pulley frame 25 is shown, to which the pulley 27 is rotably mounted on axle 33.

FIG. 7 shows a main frame 10 according to one embodiment, which is provided with a plurality of pulley assemblies 14 as described in reference to FIGS. 4, 5, and 6. In this embodiment, each pulley assembly 14 is removably attached to the wall 3 positioned as shown, as a result of the presence of pulley supports 35, which pulley supports 35 are each disposed through a hole in the wall 3 as shown and described in reference to FIG. 2. In one embodiment the pulley supports 35 are bolts that pass through holes in wall 3 and through holes 31 (FIG. 5) in the pulley assemblies 14. In another embodiment the pulley supports 35 are rivets that pass through holes in wall 3 and through holes 31 (FIG. 5) in the pulley assemblies 14; however, any conventional fastener capable of maintaining a pulley assembly 14 substantially in the position as shown in FIG. 7 is sufficient for use as a pulley support 35. Also shown in FIG. 7 are the respective locations of the lower flange 5, mounting holes 11, cable passages 15, 17 and the upper flange 7.

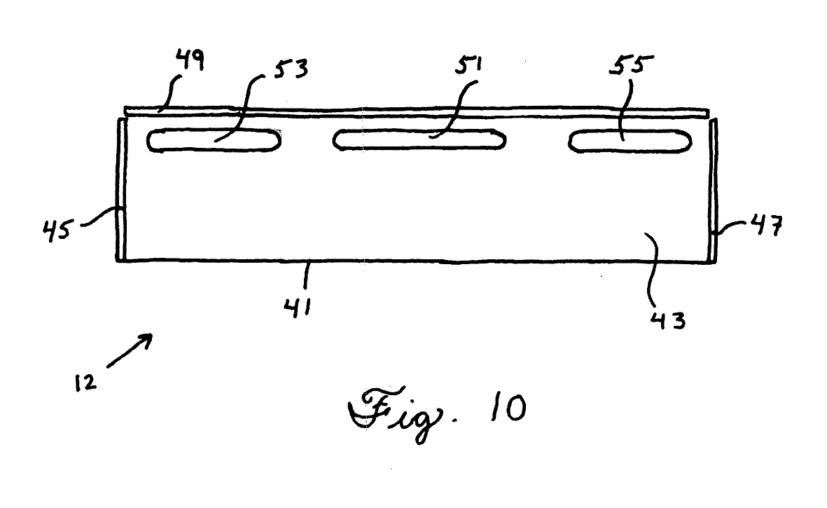

In FIG. 8 is shown an embodiment comprising the main frame 10 having features and elements as described in reference to FIG. 7 and further including a first cable 37 and a second cable 39, positioned as shown over the pulleys. The first cable 37 has a first end and a second end, wherein the first end of the first cable 37 is attached to indicator bob 69, and wherein the second end of the first cable 37 is attached to counterweight CW. The second cable 39 has a first end and a second end, wherein the first end of the second cable 39 is attached to float F, and wherein the second end of the second cable 39 is attached to counterweight CW. In this embodiment, the second end of the first cable 37 and the second end of the second cable 39 pass through slot 13 disposed through the lower flange 5. In this embodiment, the first end of the first cable 37 and the first end of the second cable 39 pass through the cable passages 15, 17 that are each disposed through the lower flange 5, respectively. Cable ends are attached to float F and indicator bob 69 by conventional means, which includes without limitation tying the cable to an eyelet present on float F and indicator bob 69. In an alternate embodiment, the first cable 37 and second cable 39 are a single cable, the first end of which is attached to float F and the second end of which is attached to the indicator bob 69, the substantial center point of which single cable in such alternate embodiment is affixed to counterweight CW, such as by a knot tied in the cable. The material from which a cable provided herein may be comprised includes any and all cable materials known, including without limitation ropes comprised of fibers, natural or synthetic; twines; wires including steel wire; and polymeric ropes and twines such as polypropylene ropes and nylon ropes and twines. Both braided and non-braided cable materials are suitable for use herein, whether coated with a polymeric material or not. In one embodiment, the cable material is braided steel cable having a polymeric coating.

The arrangement of the embodiment shown in FIG. 8 provides that the lengths of the cable(s) may be selected to be any length that enables the level of liquid contained in a vessel such as a storage tank to be indicated by the indicator bob 69. In operation, the vertical position of float F is controlled by the level of liquid disposed in a storage vessel such as a tank, as the float F is caused to be disposed within the storage vessel, a gauge control assembly 16 (FIG. 14) comprising the features shown in FIG. 8 being mounted atop a storage tank. As the liquid level within a storage tank is caused to decrease, the float F moves downwards with the surface of the liquid, and appropriate selection of the masses of the float F, counterweight CW and indicator bob 69 then provide that the counterweight CW will move upwards, simultaneously lowering the level of indicator bob 69. Selecting the length of the cable(s) appropriately ensures that the vertical location of the indicator bob 69 on the outside of a storage tank coincides substantially with the liquid level within the tank. The cable(s) are attached by conventional means to the float F, counterweight CW and indicator bob 69, which may include hooks, loops or eyelets to which the cable(s) are attached, cable attachments to weights, floats and the like being well-known in the art.

One advantage of a gauge control assembly 16 that includes the arrangement shown and described in relation to FIG. 8 is that the cable passages 15, 17 and slot 13 may be dimensioned to be only slightly larger than the outside diameter of the cable(s), which prevents insects such as mud daubers (wasps which build mud nests) from building their nests within the assembly, which can foul operation of the gauge assembly. In one embodiment, the cover and frame are dimensioned sufficiently to preclude insects having a body dimension greater than about two millimeters from entering the interior space of the frame and cover combination. When a cover as to be described herein is provided over the main frame 10, all pulleys and cables are completely encased within an enclosure provided by such a combination, which provides an added benefit of shielding the mechanism within the enclosure from fouling due to ambient weather conditions. Particularly detrimental weather conditions that foul similar tank gauge systems include rain, followed by sub-freezing temperatures, which causes ice to solidify, preventing operation of the mechanism. In the embodiment shown in FIG. 8 the pulley supports 35 are threaded bolts, and shown in the absence of nuts or other fasteners, for purposes of illustration only.

FIG. 9 shows a front perspective view of a cover 12 for a main frame 10 of an assembly according to an embodiment of the present invention. The cover 12 comprises a wall 41 having an interior surface 43. There is also a first end flange 45, a second end flange 47, and an upper flange 49. Construction of the cover 12 may be similar to that of the main frame 10, being comprised potentially from the same materials, including polymers, sheet steel galvanized or not, or stainless steel. When steel sheet stock is selected, the cover 12 may be provided by cutting to the necessary shape, and then bending the edges to form the flanges 45, 47, 49.

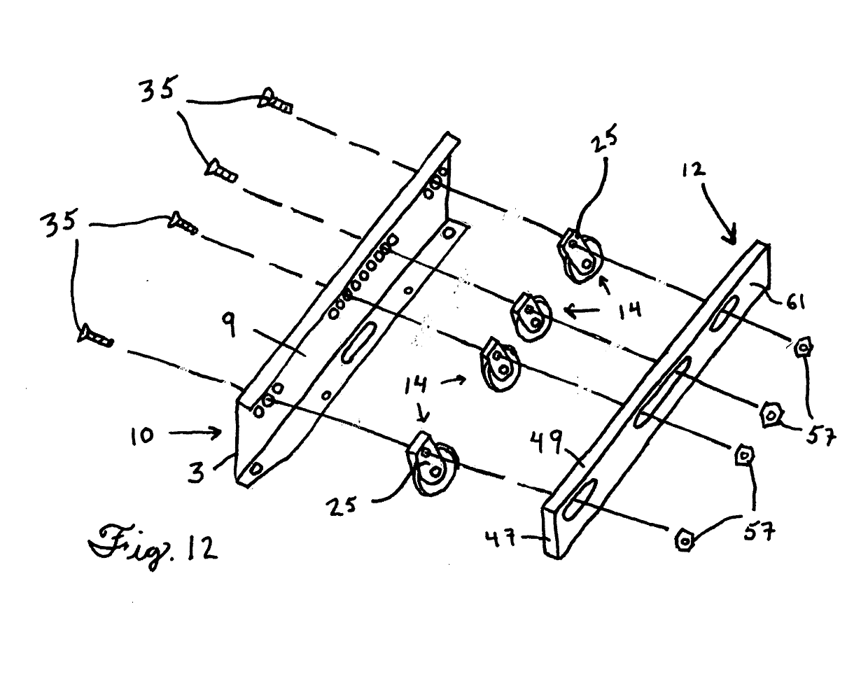

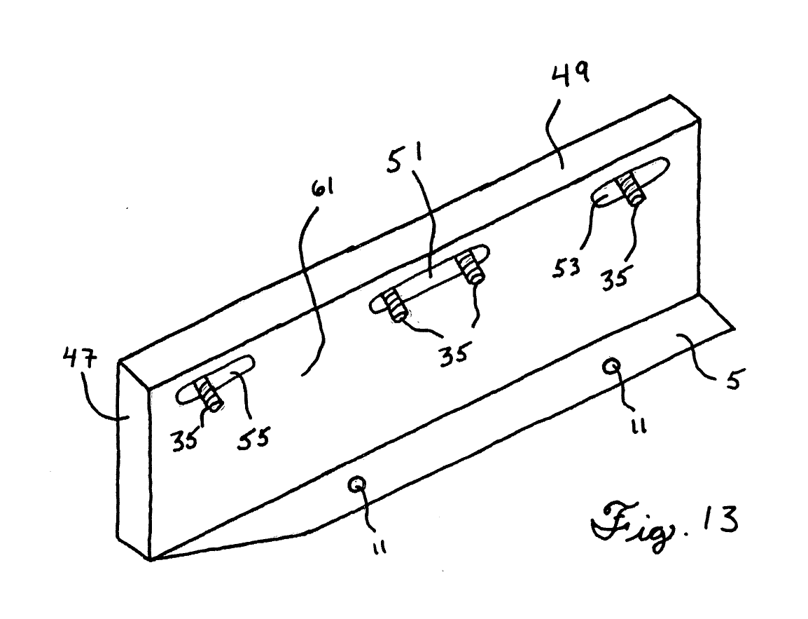

FIG. 10 shows a front view of a cover 12 for a main frame 10 of an assembly 16 according to an embodiment of the present invention. Shown in FIG. 10 are the respective locations of the wall 41, interior surface 43, first end flange 45, second end flange 47, and upper flange 49. Also shown are first slot 51, second slot 53, and third slot 55. These slots are dimensioned in one embodiment to coincide substantially in location with the pluralities of holes 19, 21, and 23 shown in FIG. 2, when a cover 12 is combined with a main frame 10 (FIG. 2) as shown in FIG. 12 to provide a combination shown in FIG. 13. In alternate embodiments, when single holes are present at the locations specified for the pluralities of holes 19, 23 in FIG. 2, and where two holes are provided for the plurality of holes 21 in FIG. 2, to provide the construct shown in FIGS. 7 and 8, two holes are present at the location specified for the first slot 51 in FIG. 10, one hole is present at the location specified for the second slot 53 in FIG. 10, and one hole is present at the location specified for the third slot 55 in FIG. 10. The selection of an embodiment in which the cover 12 comprises a first slot 51, second slot 53, and third slot 55 is advantageous when the mainframe 10 is selected to comprise first, second, and third pluralities of holes 19, 21, and 23 as shown in FIG. 2, as a combination including such features may accommodate pulley assemblies 14 of varied sizes, and tank roofs having various pitches, by changing the hole through which the pulley supports 35 are disposed.

In FIG. 11 is shown a rear perspective view of a cover 12 for a main frame 10 of an assembly according to an embodiment of the present invention. The wall 41 is shown, having an exterior surface 61. Also shown are the respective locations of the first slot 51, second slot 53, and third slot 55 disposed through the wall 41, as well as the second end flange 47 and upper flange 49.

FIG. 12 shows an exploded view of various components of an assembly provided in accordance with one embodiment of the invention. Shown is main frame 10, pulley assemblies 14, cover 12, pulley supports 35 and fasteners 57. The long dashed lines indicate the orientation of the fasteners 57. One method for assembling the components shown according to one embodiment is to first provide the main frame 10. Pulley supports 35 are next placed through holes in the wall 3, and the holes 31 (FIG. 5) of the pulley assemblies 14 are placed over the shank portions of the pulley supports 35 to provide an assembly as shown in FIG. 7. Cables are strung over the pulleys to provide an assembly as shown and described in reference to FIG. 8, and the cover 12 is next brought into close proximity to the main frame 10 so that the shanks of the pulley supports pass through the slots 51, 53, 55 when present, or in alternate embodiments through single holes in the wall 41 of the cover 12, to provide a construct as shown in FIG. 13. Subsequently, fasteners 57 are affixed to the ends of the pulley supports 35 and tightened to be snug. Thus, in one embodiment, the main frame 10 and cover 12, when brought together to form an assembly as herein described, define within their confines an interior space which is shaped in the form of a substantially rectangular-hollow, in which is securely contained a plurality of pulley assemblies and cable(s) as has been shown, the pulley assemblies being maintained in position within the interior space by the pulley supports 35, which pulley supports 35 also function to fasten the cover 12 and main frame 10 to one another when fasteners 57 are affixed to the ends of the pulley supports 35. In one embodiment the fasteners 57 comprise wing nuts. In another embodiment, the fasteners 57 comprise threaded nuts. In another embodiment, the pulley supports 35 and fasteners 57 collectively comprise rivets; however, any suitable conventional fasteners may be employed provided they affix the pulley assemblies 14 in place within the interior space and fasten the cover 12 to the main frame 10. The interior space is bounded and defined by the inner surfaces of the wall 3, wall 41, first end flange 45, second end flange 47, lower flange 5, and upper flange 47.

In one embodiment, the cover 12 is dimensioned so that upper flange 49 is exterior to the interior space, disposed adjacent (atop) the upper flange 7 of frame 10. In another embodiment, the cover 12 is dimensioned so that the interior space is bound by upper flange 49 of the cover 12, instead of upper flange 7 of frame 10, the upper flange 7 of frame 10 in this embodiment being exterior to the interior space, disposed adjacent (atop) the upper flange 49 of cover 12.

FIG. 14 shows a schematic cross-section of a tank equipped with a tank liquid level gauge system as provided in accordance with one embodiment of the invention. In FIG. 14 is shown a tank T, having a liquid disposed within its confines. The liquid may be any liquid, as the principles of a system according to this disclosure are applicable to essentially all liquid storage tanks. A gauge control assembly 16 (including a main frame 10 and cover 12) is disposed on the top of the tank T. In one embodiment, the tank T is comprised of sheet metal, such as steel, and has a flat top surface. In other embodiments, the roofs of tanks to which a system according to this disclosure may be provided comprise roofs of pitches other than flat. The gauge control assembly 16 is as was shown in FIG. 12 and also includes cables 37, 39 present and positioned as described earlier in reference to FIG. 8. the gauge control assembly is attached to the flat top surface of the tank T by mounting screws, which may comprise sheet metal screws, disposed through the mounting holes 11, shown earlier. Initially, the liquid level in tank T is as shown. As liquid is withdrawn from the tank the vertical level of the liquid within the tank is lowered, which causes the float F to also be lowered. This action causes the counterweight CW to rise due to the arrangement of the cables as shown earlier in reference to FIG. 8, and also causes the indicator bob 69 to attendantly experience simultaneous downward movement as does the float, thereby providing a readily visible indication of tank liquid level to an observer on the outside of the tank, such as a workman. In one embodiment, the indicator bob 69 is positioned within a clear, calibrated, graduated tube 63 that is mounted to the external surface of the tank T. Using such provision enables an observer to readily determine the volume of liquid contained within the tank T from a casual glance. When the indicator bob 69 is provided with brightly-colored markings, such as its mid portion being painted bright yellow, or being provided with a reflective tape on its exterior, an observer may determine the volume of liquid within the tank T using an assembly as provided herein, from quite a distance away. In alternate embodiments, the indicator bob 69 is provided with magnetic tape, and sensors disposed along the length of a tube 63 in which the indicator bob 69 is contained can convey the tank level electronically, using position-sensing means known in the art. Since the lower flange 5 of the main frame 10 is, in such an embodiment in contact with the top surface of the tank T, insects and rain are precluded from entering the gauge control assembly 16. The walls 3, 41, the upper flange 49 and the first and second end flanges 45, 47 collectively provide a secured environment for the interior space within the gauge control assembly 16.

In one embodiment, the counterweight CW is comprised of steel; however, the counterweight may be comprised of any material provided that the material chosen is not reactive towards the liquid contained within the tank, or its vapors. In another embodiment, the counterweight comprises aluminum. In another embodiment, the counterweight comprises zinc. In another embodiment, the counterweight comprises lead. In alternate embodiments, the counterweight CW is coated with an inert coating, which can comprise powder coatings and polymeric coatings.

Similarly, the float F is preferably comprised of materials which are non-reactive towards the liquid and vapors of the liquid that is contained in a tank T whose liquid level is subject to monitoring in accordance with this disclosure.

As shown in FIG. 14, when the liquid level of the tank T is relatively low, the counterweight CW is suspended in the vapor space within the tank, being held in position by gravitational forces of the earth acting on the combined weights of the float F and indicator bob 69. However, when tank T contains more liquid than shown in FIG. 14, for example, when tank T is substantially full, the position of float F is higher from a vertical perspective, and counterweight CW is at times disposed so as to be submerged in the liquid contained within the tank T. Submersion of counterweight CW in the liquid alters the forces acting on float F, counterweight CW, and indicator bob 69 by virtue of the buoyancy of counterweight CW when submerged, i.e., the impact of gravitational forces which act on counterweight CW is different when counterweight CW is submerged within the liquid versus the case where it is suspended in the vapor space, as shown in FIG. 14, per Archimedes' principle. Accordingly, selection of the size parameters and weights of the counterweight CW, float F, and indicator bob 69 must be judiciously made in order to ensure proper operation of a system according to this disclosure. In one embodiment, counterweight CW weighs about 2 pounds and is cylindrical in shape. In the same embodiment, indicator bob 69 has a weight of about 6 ounces and is cylindrical in shape. In the same embodiment, float F is a six inch sphere comprised of polyethylene having a wall thickness of about ⅛ inch, which contains sand as a ballast material so that float F weighs a total of about one kilogram. However, the exact geometric shapes of counterweight CW, float F, and indicator bob 69 are not particularly critical, as, for example, as all could be spherical, or all could be cylindrical, or other shapes selected provided that overall function is not impaired. In particular embodiments, counterweight CW has a weight of any weight between about 1.5 pounds and about 2.5 pounds, while indicator bob 69 has any weight between about 5 ounces and about 10 ounces, float F being dimensioned and having a mass effective to provide it to be maintained in contact with the surface of the liquid disposed within a tank such as tank T. In one embodiment, float F has a specific gravity of about 0.5. Pounds and ounces as specified in this specification and the appended claims are according to the avoirdupois (Av.) system.

A gauge control assembly 16 as provided herein may be dimensioned to fit any tank, the selection of length and size variables of the various components, including pulley assemblies being within the skill level of one of ordinary skill in the art for a given end use application.

While the invention has been described by reference to certain embodiments, it is understood that changes and/or modifications can be made to elements, components, and combinations herein described without overstepping the metes and bounds of the scope of the disclosures.

Accordingly, the invention is not necessarily limited to the disclosed embodiments, but has the full scope permitted by the language of the claims which follow.

I claim:

1. Apparatus for indicating the level of a liquid disposed in a liquid storage vessel, said apparatus comprising:
a) a frame portion having a wall and a lower flange, said lower flange including a plurality of holes disposed therethrough;
b) a first pair of pulleys affixed to said frame;
c) a second pair of pulleys affixed to said frame;
d) a first length of cable having a first end and a second end, said first length of cable being in contact with each pulley of said first pair of pulleys, and passing through said lower flange at two different locations;
e) a second length of cable having a first end and a second end, said second length of cable being in contact with each pulley of said second pair of pulleys, and passing through said lower flange at two different locations;
f) an indicator bob, said indicator bob being attached to said first end of said first cable;
g) a float, said float being attached to said first end of said second cable; and
h) a counterweight, said counterweight being attached to said second end of said first length of cable and to said second end of said second length of cable.

2. An apparatus according to claim 1 and further comprising:
i) a cover attached to said frame portion.

3. An apparatus according to claim 2 wherein said cover and said frame portion collectively define a closed interior space within their confines, which interior space is shaped to be substantially as a rectangular hollow, in which hollow said pulleys and at least portions of the lengths of said cables are contained.

4. An apparatus according to claim 2 wherein each pulley present in said pairs of pulleys is attached to said frame using a fastener, and wherein said cover is attached to said frame using the same fasteners that said pulleys are attached to said frame with.

5. An apparatus according to claim 2 wherein at least one of said pulleys is mounted in a pulley frame, said pulley frame being affixed to said wall.

6. An apparatus according to claim 5 wherein each pulley present in said pairs of pulleys is attached to said frame using a fastener, and wherein said cover is attached to said frame using the same fasteners that said pulleys are attached to said frame with.

7. An apparatus according to claim 1 wherein said first length of cable and said second length of cable comprise a single cable.

8. An apparatus according to claim 1 wherein said first length of cable and said second length of cable comprise two separate cables.

9. An apparatus according to claim 1 wherein said counterweight is of sufficient mass to have any weight between about 1.5 pounds and 2.5 pounds, avoirdupois.

10. An apparatus according to claim 9 wherein said indicator bob is of sufficient mass to have any weight between about 5 ounces and about 10 ounces, avoirdupois.

11. A tank useful for storing liquids, said tank having a top surface comprising a plurality of holes disposed therethrough, an interior space, an exterior surface, and an indicator gauge attached thereto, said indicator gauge comprising:
a) a frame portion having a wall and a lower flange, said lower flange including a plurality of holes disposed therethrough;
b) a first pair of pulleys affixed to said frame;
c) a second pair of pulleys affixed to said frame;
d) a first length of cable having a first end and a second end, said first length of cable being in contact with each pulley of said first pair of pulleys, and passing through said lower flange at two different locations;
e) a second length of cable having a first end and a second end, said second length of cable being in contact with each pulley of said second pair of pulleys, and passing through said lower flange at two different locations;
f) a float, said float being attached to said first end of said first cable;
g) an indicator bob, said indicator bob being attached to said first end of said second cable; and
h) a counterweight, said counterweight being attached to said second end of said first length of cable and to said second end of said second length of cable,
said frame portion being affixed to said top surface of said tank, said float and said counterweight being disposed within the interior of said tank, said indicator bob being disposed outside of said tank, and wherein said lengths of cable pass through said holes in said top surface of said tank.

12. A tank according to claim 11 wherein said frame portion is attached to said top surface of said tank by fasteners disposed through holes present in said lower flange.

13. A tank according to claim 11 further comprising a vertically-disposed translucent tube attached to the exterior surface of said tank, and wherein said indicator bob is movably disposed within said tube.

14. A tank according to claim 13 wherein said indicator bob is provided to have magnetic properties, and wherein a magnetic sensor is disposed in operative proximity to said tube for sensing the location of said bob.

15. A tank according to claim 13, wherein said tube is graduated.

16. Apparatus useful for indicating the level of a liquid that is disposed in a liquid storage tank, comprising:
a) a frame portion having a lower flange;
b) a cover portion removably attached to said frame portion, said cover portion and said frame portion, when attached, defining an interior space that is substantially shaped in the form of a closed rectangular-hollow;
c) a plurality of pulleys disposed completely within said interior space;
d) an indicator bob;
e) a float; and
f) a counterweight operatively attached to both of said indicator bob and said float by cable disposed in contact with said pulleys, said cable extending through holes in said lower flange.

17. Apparatus according to claim 16 wherein said apparatus is configured to be disposed on top of a liquid storage tank in effective arrangement having said float in contact with liquid contained within said tank, so that a change in liquid level within said storage tank is accompanied by a corresponding simultaneous change in position of said indicator bob.

18. Apparatus according to claim 16 wherein said frame and said cover are dimensioned sufficiently to preclude atmospheric precipitation from contacting said pulleys.

19. Apparatus according to claim 16 wherein said frame and said cover are dimensioned sufficiently to preclude insects having a body dimension greater than about two millimeters from entering said interior space.

20. Apparatus according to claim 16, further comprising a storage tank having an interior with a liquid disposed therein, said apparatus being disposed on said roof such that said float is in contact with said liquid and said counterweight is disposed within said interior, and the indicator bob being disposed outside of said interior, the combination being arranged so that changes in the vertical position of said indicator bob is responsive to changes to the level of said liquid.
